(19) United States
(12) Patent Application Publication
(10) Pub. No.: US 2011/0164887 A1
(43) Pub. Date: Jul. 7, 2011

(54) IMAGE FORMING APPARATUS

(75) Inventor: Sunao Takenaka, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/971,158

(22) Filed: Dec. 17, 2010

Related U.S. Application Data
(60) Provisional application No. 61/292,053, filed on Jan. 4, 2010.

(51) Int. Cl. G03G 15/00

(52) U.S. Cl. 399/16

(57) ABSTRACT

According to one embodiment, an image forming apparatus includes a setting unit configured to set setting information for forming images on recording media, one or more feeding units configured to store the recording media, a media sensor configured to detect a characteristic value of the recording media stored in the feeding units, an image forming unit configured to form images on the recording media on the basis of a detection result of the media sensor, and a control unit configured to cause, at a time when a feeding unit that feeds the recording media is selected on the basis of the setting from the setting unit, the media sensor to detect a characteristic value of the recording media in the selected feeding unit and cause the image forming unit to satisfy at least one image forming condition on the basis of the detected characteristic value of the recording media.

### CROSS-REFERENCE TO RELATED APPLICATIONS

This application is based upon and claims the benefit of U.S. Provisional Application No. 61/292,053, filed on Jan. 4, 2010; the entire contents of which are incorporated herein by reference.

### FIELD

Embodiments described herein relate generally to an image forming apparatus.

### BACKGROUND

An image forming apparatus transfers a developer image formed on a photoconductive member or an intermediate transfer member onto recording media such as sheets and heats to fix the image in a device at a post stage of the image forming apparatus. Therefore, characteristics concerning the recording media such as the resistance, the basis weight, and the surface properties of the recording media affect the quality of images formed by the image forming apparatus.

In the past, an image forming apparatus such as a digital multi function peripheral (MFP) includes plural media sensors configured to detect characteristics of recording media. The image forming apparatus selects operation conditions such as conveying speed, fixing temperature, and fixing nip optimum for the recording media on the basis of a detection result of the media sensors. The image forming apparatus controls an image forming operation according to the selected operation conditions.

Various techniques are known and disclosed as techniques for detecting characteristics of the recording media and feeding back the characteristics to the image forming apparatus. However, when these techniques are put to practical use, time from the detection of the characteristics of the recording media to the feedback is often insufficient. Therefore, for example, the conveying speed for the recording media is reduced or an interval of supply of the recording media is increased. As a result, the performance of the image forming apparatus is deteriorated.

Therefore, there is a need for a technique that can suppress deterioration in performance in an image forming apparatus that detects characteristic values affecting the quality of images formed on recording media and feeds back the characteristic values.

### BRIEF DESCRIPTION OF THE DRAWINGS

FIG. 1 is an exemplary diagram of a network configuration and an external configuration of an image forming apparatus according to an embodiment;

FIG. 2 is an exemplary schematic diagram of an internal configuration of the image forming apparatus according to an embodiment;

FIG. 3 is an exemplary block diagram for explaining the configuration of a control system of the image forming apparatus according to an embodiment;

FIG. 4 is an exemplary external view of a control panel provided in the image forming apparatus according to an embodiment;

FIG. 5 is an exemplary diagram of an operation screen for selecting a feeding cassette using a printer driver according to an embodiment;

FIG. 6 is an exemplary flowchart for explaining a print processing procedure in the image forming apparatus according to an embodiment;

FIG. 7 is an exemplary flowchart for explaining an adaptive processing procedure in the image forming apparatus according to an embodiment;

FIG. 8 is an exemplary diagram of an example of a media sensor configured to detect the surface resistance of recording media according to an embodiment;

FIG. 9 is an exemplary diagram of another example of the media sensor configured to detect the characteristics of recording media according to an embodiment;

FIG. 10 is an exemplary flowchart for explaining a print processing procedure performed when a feeding cassette is designated on a control panel of the image forming apparatus according to an embodiment;

FIG. 11 is an exemplary flowchart for explaining a print processing procedure performed when an automatic sheet selection button is operated on the control panel of the image forming apparatus according to an embodiment; and

FIG. 12 is an exemplary diagram of an operation screen for selecting a feeding cassette displayed on the control panel according to an embodiment.

### DETAILED DESCRIPTION

In general, according to one embodiment, an image forming apparatus includes: a setting unit configured to set setting information for forming images on recording media; one or more feeding units configured to store the recording media; a media sensor configured to detect a characteristic value of the recording media stored in the feeding units; an image forming unit configured to form images on the recording media on the basis of a detection result of the media sensor; and a control unit configured to cause, at a time when a feeding unit that feeds the recording media is selected on the basis of the setting from the setting unit, the media sensor to detect a characteristic value of the recording media in the selected feeding unit and cause the image forming unit to satisfy at least one image forming condition on the basis of the detected characteristic value of the recording media.

An image forming apparatus and an image forming method according to an embodiment of the present invention are explained with reference to the accompanying drawings.

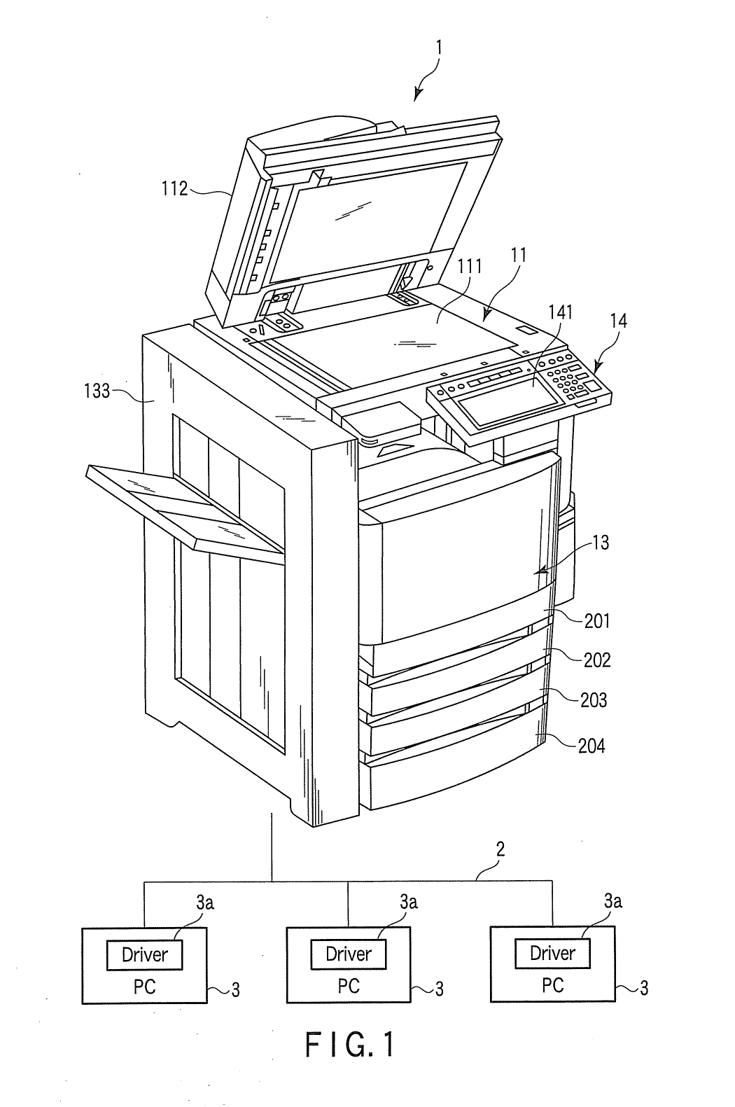

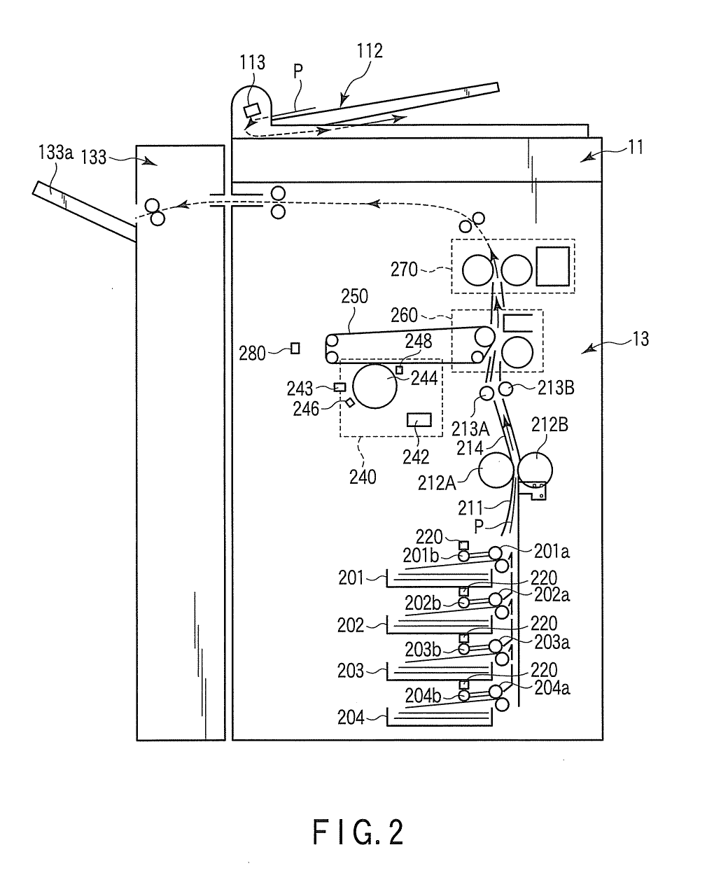

FIG. 1 is an exemplary diagram of a network configuration and an external configuration of the image forming apparatus according to the embodiment. FIG. 2 is an exemplary schematic diagram of an internal configuration of the image forming apparatus according to the embodiment.

An image forming apparatus 1 is connected to personal computers (PCs) 3 via a network 2. The PCs 3 include drivers 3a for using the image forming apparatus 1 as a printer terminal. A user can not only directly operate the image forming apparatus 1 using a control panel 14 of the image forming apparatus 1 but also operate the image forming apparatus 1 using the drivers 3a of the PCs 3.

As shown in FIG. 1, a main body of the image forming apparatus 1 includes units such as a scanner 11, a printer 13, and the control panel 14.

The scanner 11 is set in an upper part of the main body of the image forming apparatus 1. The scanner 11 is an apparatus that optically reads an image of an original document. The scanner 11 includes a not-shown CCD line sensor. The CCD line sensor reads an image in one line in a main scanning direction in the original document. The scanner 11 reads an image of the entire original document by causing the CCD line sensor to scan in a sub-scanning direction of the original document. For example, the scanner 11 reads an image of an entire original document placed on a document table 111 by causing the CCD line sensor to scan in the sub-scanning direction with respect to the original document.

In configuration examples shown in FIGS. 1 and 2, the scanner 11 includes an auto document feeder (ADF) 112. The ADF 112 is arranged in an upper part of the main body of the image forming apparatus 1. The ADF 112 conveys sheet-like original documents one by one. The scanner 11 reads an image of the original document conveyed by the ADF 112. The ADF 112 is set in the upper part of the image forming apparatus 1 such that the entire ADF 112 opens and closes. In a closed state, the ADF 112 also functions as a cover for an original document placed on the document table 111. The ADF 112 includes a media sensor 113. The media sensor 113 is a sensor configured to detect characteristic information indicating characteristics of an original document to be conveyed. For example, the media sensor 113 detects information indicating the thickness, the degree of gloss, the material, or the like of the original document.

The control panel 14 is set in a front section on the upper surface of the main body of the image forming apparatus 1. The control panel 14 is used to display guidance to the user and receive an instruction input from the user. For example, the user instructs copy conditions or copy start using the control panel 14.

The control panel 14 includes various operation keys and various displays. For example, the control panel 14 includes a touch panel display 141 as a display incorporating a touch panel. When the user displays the various kinds of information or input the information, the user touches an icon indicating desired instruction content among icons displayed on the touch panel display 141 while checking the information displayed on the touch panel display 141.

The printer 13 includes a paper feeding mechanism, a printing mechanism, and a finishing mechanism. The paper feeding mechanism stores recording media, which are media on which images are formed. The paper feeding mechanism feeds the stored recording media to the printing mechanism one by one. The printing mechanism forms an image on the recording medium fed by the paper feeding mechanism. For example, as the printing mechanism, various printing systems such as an electrophotographic system, an ink jet system, or a thermal transfer system can be applied. In this embodiment, it is assumed that the electrophotographic system is applied as the printing mechanism. The finishing mechanism processes recording media on which images are printed by the printing mechanism. For example, the finishing mechanism applies stapling, hole punching, or the like to recording media subjected to the print processing. In an example of a digital multi function peripheral shown in FIGS. 1 and 2, a finisher 133 is set as the finishing mechanism.

As shown in FIGS. 1 and 2, the printer 13 includes feeding cassettes 201, 202, 203, and 204. The feeding cassettes 201, 202, 203, and 204 store recording media to be subjected to the print processing by the printing mechanism. For example, the feeding cassettes 201, 202, 203, and 204 are detachably attached to a lower part of the main body of the image forming apparatus 1. The feeding cassettes 201, 202, 203, and 204 store various recording media set by the user. Usually, the feeding cassettes 201, 202, 203, and 204 respectively store the same types of recording media. In this case, the feeding cassette for selecting a type of recording media is selected.

The feeding cassettes 201, 202, 203, and 204 respectively include paper feeding rollers 201a, 202a, 203a, and 204a and pickup rollers 201b, 202b, 203b, and 204b. The pickup rollers 201b, 202b, 203b, and 204b extract the recording media stored in the feeding cassettes 201, 202, 203, and 204 one by one. The paper feeding rollers 201a, 202a, 203a, and 204a send the extracted recording medium to a conveying path. The recording medium is conveyed through conveying paths 211 and 214 by conveying rollers 212 (212A and 212B) and the like. The recording medium is conveyed to registration rollers 213 (213A and 213B) through the conveying paths 211 and 214.

The registration rollers 213 (213A and 213B) are a pair of rollers provided in a position before the recording medium enters the printing mechanism. The registration rollers 213 convey the recording medium, which is conveyed through the conveying paths 211 and 214, to a secondary transfer unit as the printing mechanism at desired timing.

The pickup rollers 201b, 202b, 203b, and 204b respectively include media sensors 220. The media sensors 220 are sensors configured to detect characteristics of the recording media stored on the feeding cassettes 201, 202, 203, and 204. For example, the media sensors 220 detect information indicating the surface resistances, the thicknesses, the degrees of gloss, the materials, or the like of the recording media. The media sensors 220 may have a configuration same as that of the media sensor 113 included in the ADF 112.

The printing mechanism includes a photoconductive drum 244, an exposure device 242, a developing device 243, an intermediate transfer member 250, a secondary transfer unit 260, a fixing unit 270, and a temperature and humidity sensor 280.

Further, the printing mechanism includes a potential sensor 246 and a density sensor 248. The potential sensor 246 is a sensor configured to detect the surface potential of the photoconductive drum 244. The density sensor 248 is a sensor configured to detect the density of a toner image formed on the photoconductive drum 244 or the intermediate transfer member 250. The surface of the photoconductive drum 244 is charged by a not-shown electrifying charger. The exposure device 242 forms an electrostatic latent image on the photoconductive drum 244, the surface of which is charged. When a toner is supplied to the surface of the photoconductive drum 244, the electrostatic latent image on the photoconductive drum 244 changes to a toner image. The photoconductive drum 244 transfers the toner image formed on the surface onto the intermediate transfer member 250.

The intermediate transfer member 250 supplies the toner image, which is transferred from the photoconductive drum 244, to the secondary transfer unit 260. The secondary transfer unit 260 transfers the toner image, which is supplied by the intermediate transfer member 250, onto the recording medium. The registration rollers 213 feed the recording medium to the secondary transfer unit 260 according to the position of the toner image formed on the intermediate transfer member 250. The secondary transfer unit 260 feeds the recording medium having the toner image transferred thereon to the fixing unit 270.

The fixing unit 270 includes a heater, a heat roller, and a press roller. The fixing unit 270 fixes the toner image on the recording medium using the heat roller and the press roller heated by the heater. In other words, the fixing unit 270 heats the recording medium having the toner image transferred thereon by the secondary transfer unit 260 in a pressed state. The recording medium subjected to the fixing processing by the fixing unit 270 is conveyed to the finisher 133.

The finisher 133 processes recording media having images formed thereon by the printing mechanism. The finisher 133 includes a paper discharge tray on which the recording media having the images formed thereon by the printing mechanism are accumulated. The finisher 133 may also have a function of stapling or hole-punching the recording media accumulated on the paper discharge tray.

The temperature and humidity sensor 280 is a sensor configured to detect a state in the printer 13. The temperature and humidity sensor 280 detects the temperature and the humidity in the printer 13. The temperature and humidity sensor 280 is set, for example, in a place in the printer 13 where the temperature and humidity sensor 280 is less easily affected by a local temperature rise due to the heater in the fixing unit 270, various motors, or the like.

The configuration of a control system in the image forming apparatus 1 configured as above is explained.

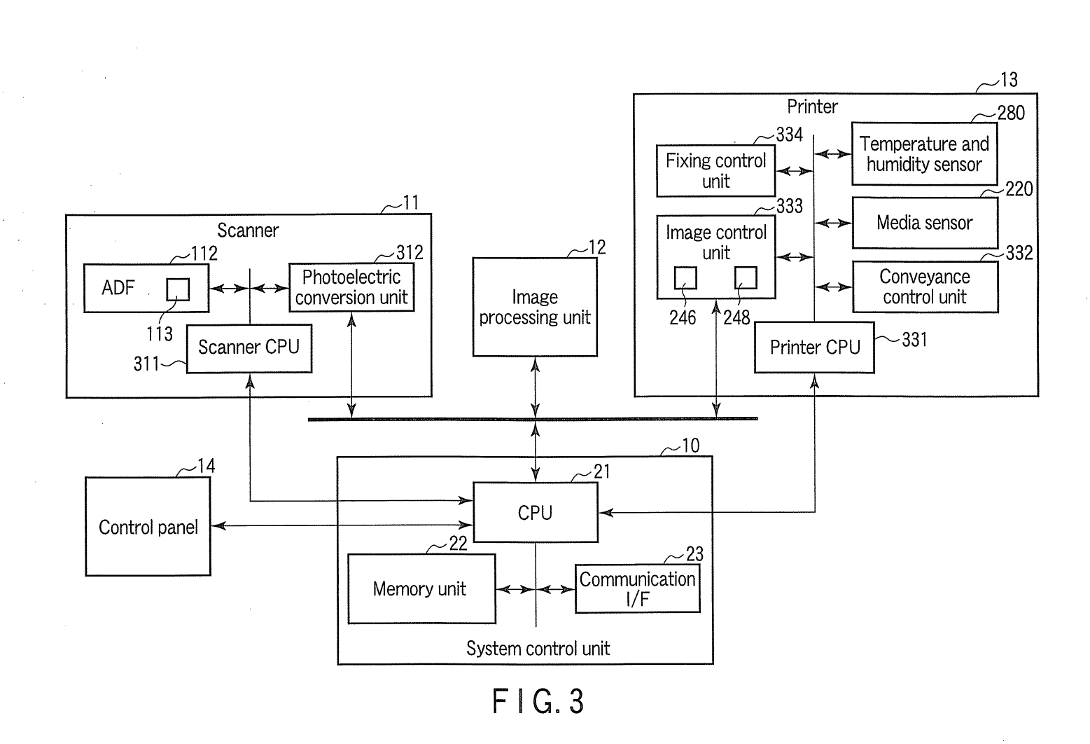

FIG. 3 is an exemplary block diagram for explaining the configuration of the control system of the image forming apparatus according to an embodiment.

The image forming apparatus 1 includes a system control unit 10, the scanner 11, an image processing unit 12, the printer 13, and the control panel 14.

The system control unit 10 includes a CPU 21, a memory unit 22, and a communication interface (I/F) 23.

The CPU 21 is connected to the scanner 11, the image processing unit 12, the printer 13, the control panel 14, and the like via a not-shown internal interface. Specifically, through two-way communication with the scanner 11, the image processing unit 12, the printer 13, and the control panel 14, the CPU 21 outputs operation instructions to the units and acquires various kinds of information from the units. For example, the CPU 21 outputs setting information related to the print processing to the printer 13 and acquires information indicating a print processing result from the printer 13. In this case, the information indicating the print processing result also includes information detected by sensors such as the media sensors 220, the potential sensor 246, the density sensor 248, and the temperature and humidity sensor 280.

The memory unit 22 stores, for example, setting information of the print processing (information indicating the size of recording media, a color mode, a duplex mode, presence or absence of electronic sort, and the like) and information detected by the sensors such as the media sensors 220, the temperature and humidity sensor 280, the potential sensor 246, and the density sensor 248 during the print processing.

Further, the CPU 21 controls an imaging system operation on the basis of the information concerning the characteristics of the recording media detected by the media sensors 220. Details of the control are explained later.

The scanner 11 includes a scanner CPU 311, a photoelectric conversion unit 312, the ADF 112, the media sensor 113.

The scanner CPU 311 manages control in the scanner 11. The scanner CPU 311 executes a control program stored in a not-shown memory to thereby realize a function of controlling the units in the scanner 11. The ADF 112 is an apparatus that conveys original documents one by one as explained above. The ADF 112 conveys the original document such that the surface of the original document passes a predetermined main scanning position in the sub-scanning direction. The media sensor 113 detects characteristic information of the original document conveyed by the ADF 112. The information detected by the media sensor 113 is supplied to the scanner CPU 311.

The photoelectric conversion unit 312 converts information obtained by optically scanning the surface of the original document into image data. The photoelectric conversion unit 312 includes an exposure device and a line sensor. The exposure device exposes the surface of the original document to light. In the line sensor, photoelectric conversion elements for converting light into an electric signal are arrayed in one line in the main scanning direction. In other words, the line sensor reads image information for one line in the main scanning direction. As components for reading an image of an original document on the document table 111, the scanner 11 also includes an exposure device and a driving unit configured to move a carriage mounted with a line sensor in the sub-scanning direction.

The printer 13 includes, as components of the control system, a printer CPU 331, a conveyance control unit 332, an image control unit 333, a fixing control unit 334, the media sensor 220, the potential sensor 246, the density sensor 248, and the temperature and humidity sensor 280.

The printer CPU 331 manages control in the printer 13. The printer CPU 331 also executes the control program stored in the not-shown memory to thereby realize a function of controlling the units in the printer 13. The conveyance control unit 332 controls conveyance of the recording medium in the printer 13.

The image control unit 333 controls processing for forming an image in the printer 13. The image control unit 333 controls an image generating unit 240 including the exposure device 242 and the photoconductive drum 244. The image control unit 333 supplies, every time the print processing is applied to a recording medium, detection results by the potential sensor 246 and the density sensor 248 to the printer CPU 331. The fixing control unit 334 controls the fixing unit 270. For example, the fixing control unit 334 controls fixing temperature in the fixing unit 270.

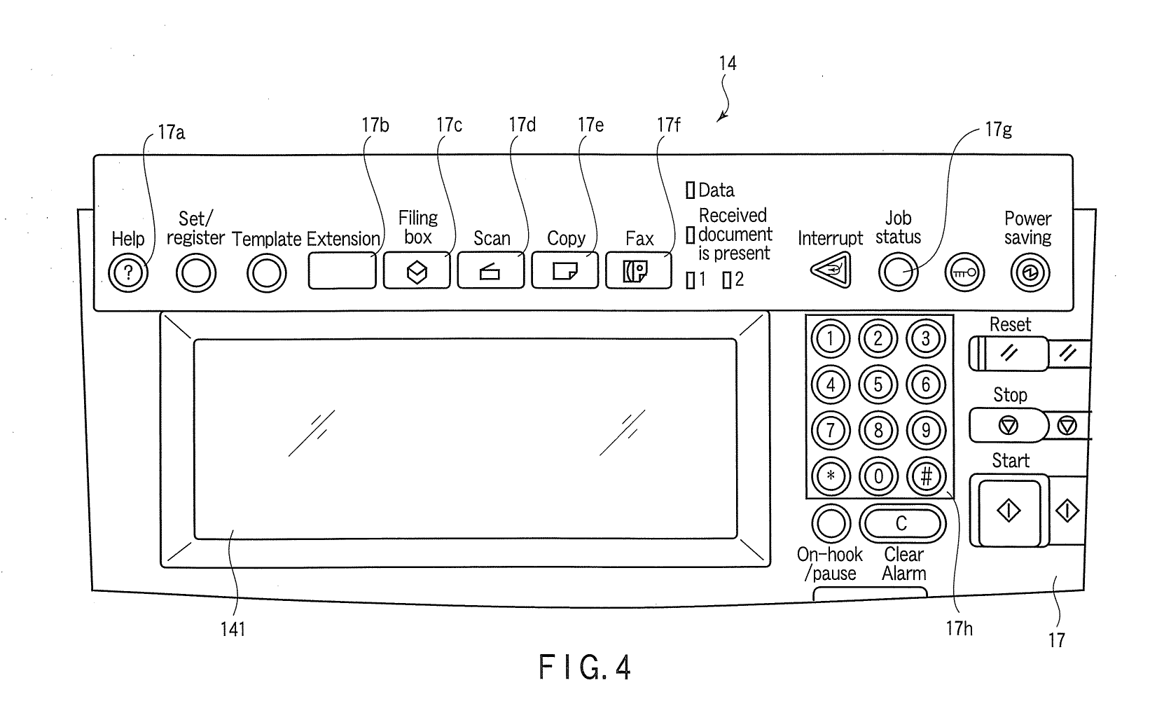

FIG. 4 is an exemplary external view of the control panel provided in the image forming apparatus according to an embodiment. The control panel 14 includes the touch panel display 141 and an operation unit 17. The touch panel display 141 includes a touch panel. A state of the image forming apparatus 1, an operation procedure, various instructions given to the user, and the like are displayed on the touch panel display 141. Various operation buttons for operating the image forming apparatus 1 are provided in the operation unit 17.

As keys for selecting functions and invoking screens to be set, a help button 17a, a function extension button 17b, a filing box button 17c, a scan button 17d, a copy button 17e, a facsimile button 17f, a status check button 17g, and the like are arranged. Besides, for example, number keys 17h for setting value input and information check are arranged.

Functions of main buttons among these operation buttons are explained below. The help button 17a is used in inquiring, for example, what kind of operation should be performed next. The extension button 17b is operated in using an extension function. The filing box button 17c is used in extracting stored image data. The scan button 17d is used in using a scan function. The copy button 17e is used in using a copy function. The facsimile button 17f is used in using a facsimile function. The status check button 17g is used in, for example, execute private printing. The number keys 17h are used in inputting a number.

A form of using the image forming apparatus 1 from the PC 3 using the printer driver 3a is explained below.

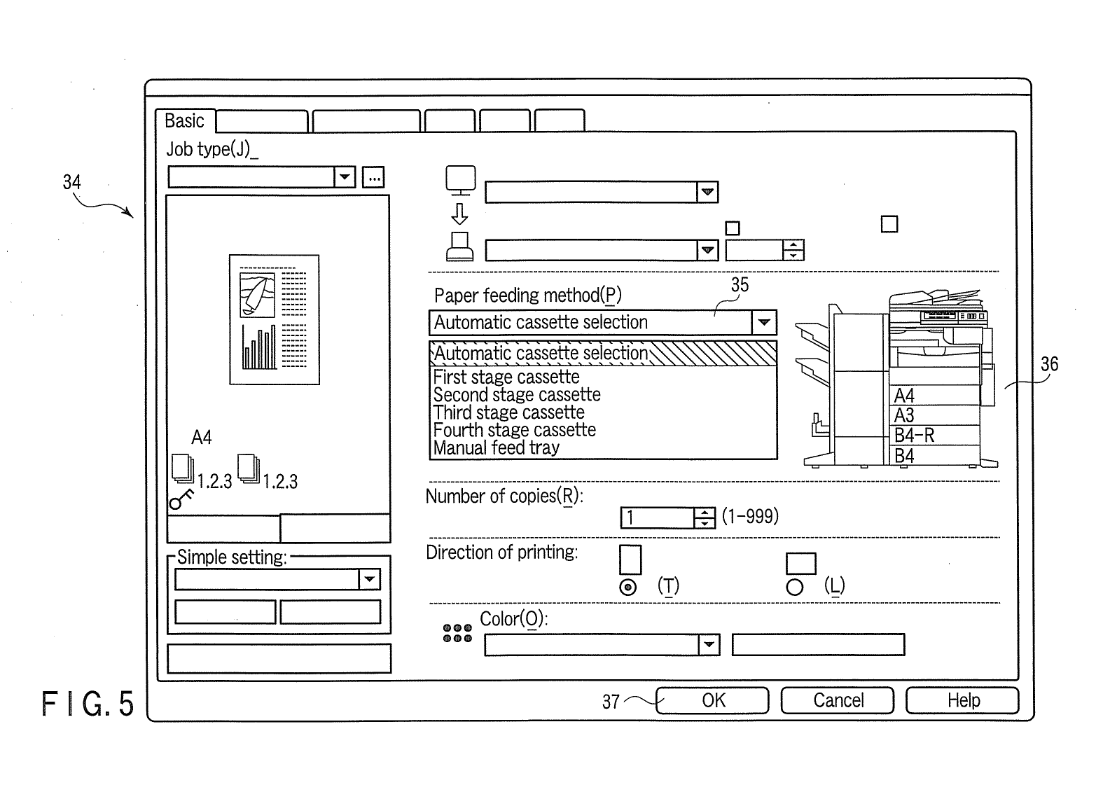

FIG. 5 is an explanatory diagram of an operation screen for selecting a feeding cassette using the printer driver according to an embodiment.

An operation screen 34 includes a dialog box for setting various conditions for printing, operation buttons, and an icon 36 of feeding cassettes. Sizes of recording media are displayed on the icon 36 of feeding cassettes. The user designates, from a dialog box 35 of a paper feeding method, a feeding cassette used for printing referring to the icon 36 of feeding cassettes. For example, the user selects any one of “automatic cassette selection”, “first stage cassette”, “second stage cassette”, . . . , and “manual feed tray” from a pull-down menu. When the designation of the feeding cassette is decided, the PC 3 transmits selection information of the feeding cassette to the image forming apparatus 1.

When the user selects a text, an image, or the like to be printed, designates a printing range, the number of copies, and the like, and presses an OK button, the PC 3 transmits the information selected on the operation screen 34 to the image forming apparatus 1 together with PDL (Page Description Language) data or raster data indicating the structure of image data.

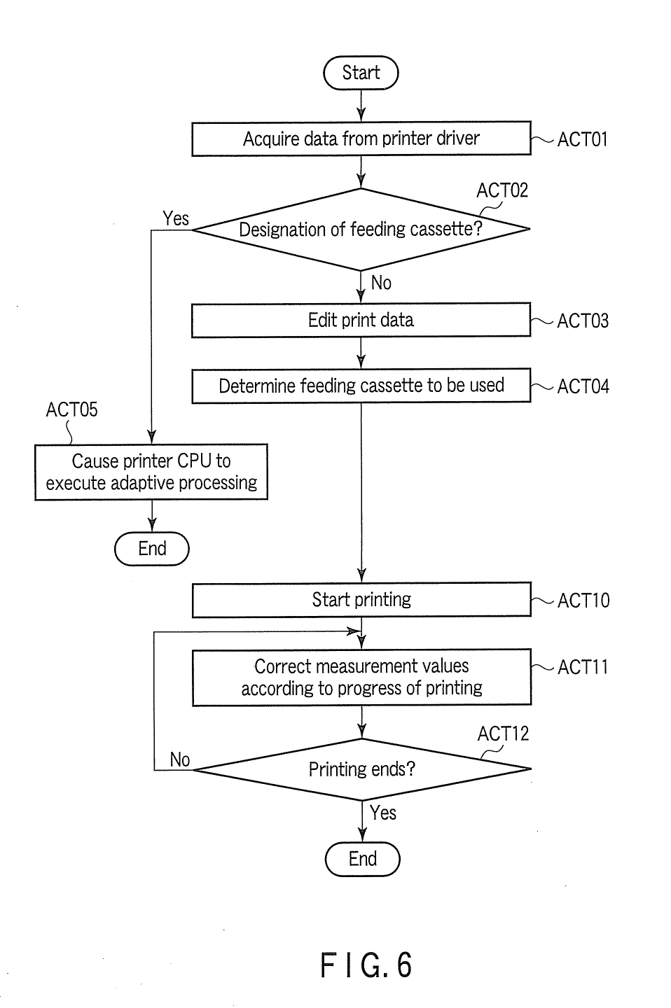

FIG. 6 is an exemplary flow chart for explaining a print processing procedure in the image forming apparatus according to an embodiment.

In Act 01, the CPU 21 acquires transmission data from the printer driver via the communication interface 23. In Act 02, the CPU 21 checks whether the transmitted information is a designation (selection information) of a feeding cassette.

If the transmitted information is the designation of a feeding cassette (Yes in Act 02), the CPU 21, in Act 05, causes the printer CPU 331 to execute adaptive processing. Then, the CPU 21 ends the processing.

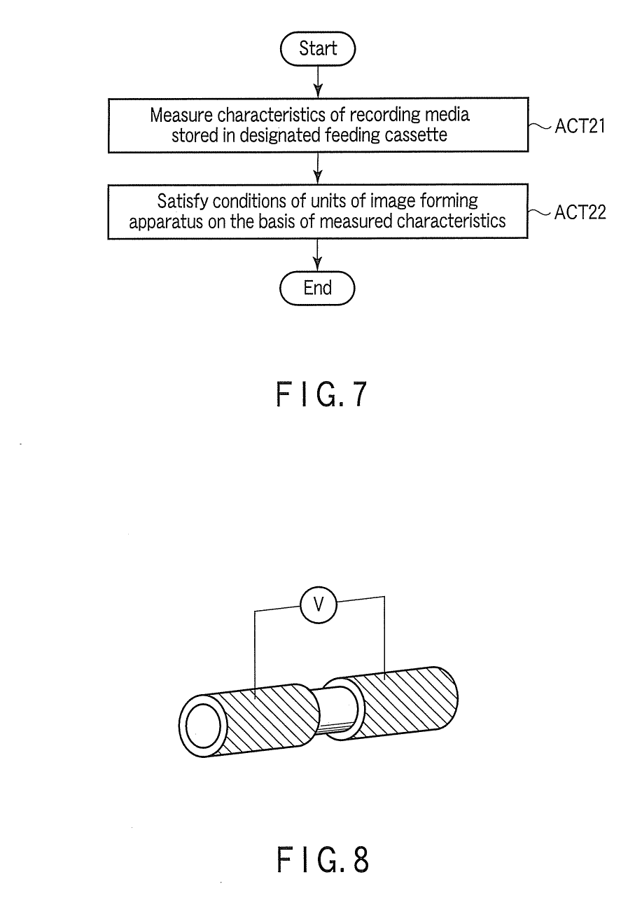

FIG. 7 is an exemplary flowchart for explaining an adaptive processing procedure in the image forming apparatus according to an embodiment.

In Act 21, the printer CPU 331 measures characteristics of recording media stored in the designated feeding cassette using the media sensor 220 provided in the feeding cassette. Measurement values of the characteristics are stored in the memory unit 22.

FIG. 8 is an exemplary diagram of an example of the media sensor configured to detect the surface resistance of recording media according to an embodiment. The feeding cassette 201 is explained as an example.

The media sensor 220 shown in FIG. 8 is configured as the pickup roller 201b to detect the surface resistance of recording media. A shaft of the pickup roller 201b is formed of a non-conductive material. The shaft is covered with a conductive material electrically divided into two areas. As the conductive material, metal, conductive rubber (conductive EPDM), or the like is used. Bias voltage for measuring the resistance of recording media is applied to the two areas.

When the printer CPU 331 outputs an instruction for measuring characteristics of recording media, the recording media in the feeding cassette 201 are pushed up from the bottom by a driving member (not shown) provided on the bottom of the feeding cassette 201 and come into contact with the pickup roller 201b. An electric current corresponding to the resistance of the recording media in contact with the pickup roller 201b flows between the two areas of the pickup roller 201b. It is possible to obtain resistance characteristics of the recording media by measuring this electric current.

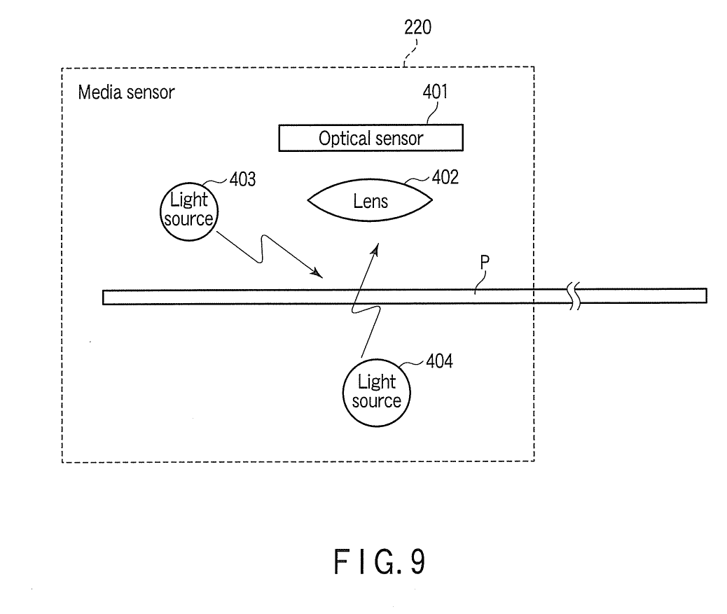

FIG. 9 is an exemplary diagram of another example of the media sensor configured to detect characteristics of recording media according to an embodiment.

In the configuration example shown in FIG. 9, the media sensor 220 includes an optical sensor 401, a lens 402, a light source for reflection 403, and a light source 404 for transmission. The media sensor 220 is mounted on the pickup roller 201b of each of the feeding cassettes 201. In the media sensor 220, the light source for reflection 403 irradiates light for inspection on a recording medium P.

For example, when a surface state of the recording medium P is detected, the light source for reflection 403 irradiates light on the surface of the recording medium P. The light emitted from the light source for reflection 403 is diffused and reflected according to the surface state of the recording medium P. The lens 402 condenses the light dispersed and reflected on the surface of the recording medium P. The optical sensor 401 converts the reflected light from the surface of the recording medium P condensed by the lens 402 into an electric signal. The electric, signal indicates a light amount of the reflected light that changes according to the surface state of the recording medium P.

As the reflectance of the light on the surface of the recording medium P is higher, the optical sensor 401 outputs an electric signal having a larger value. If a type of the recording medium P can be discriminated according to the reflectance of the light on the surface of the recording medium P, a signal output from the optical sensor 401 is information indicating the type of the recording medium. Here, as the types of the recording medium, plain paper, coat paper, and an OHP sheet are assumed. The reflectance of the light on the surface is smaller in the order of the plain paper, the coat paper, and the OHP sheet. Therefore, it is possible to set thresholds for discriminating the plain paper, the coat paper, and the OHP sheet with respect to the electric signal output from the optical sensor 401. The media sensor 220 can detect which of the plain paper, the coat paper, and the OHP sheet the recording medium P is by comparing such thresholds and a value of the electric signal output from the optical sensor 401.

When the pickup roller 201b is not only pressed against the recording medium P but includes a mechanism for lifting an end of one recording medium, it is possible to detect the transmittance of the light on the recording medium P by using the light source for transmission 404. The light source for transmission 404 irradiates light on the recording medium P. The light emitted from the light source for transmission 404 is transmitted according to the thickness or the like of the recording medium P. In other words, the light emitted from the light source for transmission 404 changes to transmission light having a light amount corresponding to the thickness or the like of the recording medium P and is transmitted through the recording medium P. The lens 402 condenses the light transmitted through the recording medium P. The optical sensor 401 converts the transmission light of the recording medium P condensed by the lens 402 into an electric signal. The electric signal indicates the light amount of the transmission light that changes according to the thickness or the like of the recording medium P.

As the thickness of the recording medium P is smaller, the transmittance of the light on the recording medium P is higher. Therefore, as the transmittance of the light on the recording medium P is higher, the optical sensor 401 outputs an electric signal having a larger value. If the thickness of the recording medium P can be discriminated according to such transmittance of the light on the recording medium P, a signal output from the optical sensor 401 is information indicating a type of the recording medium. Concerning the thicknesses of the recording medium, thin paper, plain paper, and thick paper are assumed. In such a case, the transmittance of the light on the recording medium is larger in the order of the thin paper, the plain paper, and the thick paper. Therefore, it is possible to set thresholds for discriminating the thin paper, the plain paper, and the thick paper with respect to the electric signal output from the optical sensor 401. The media sensor 220 can detect which of the thin paper, the plain paper, and the thick paper the recording medium P is by comparing such thresholds and a value of the electric signal output from the optical sensor 401.

The media sensor 220 is not limited to the configuration explained above. The media sensor 220 may be configured by combining plural sensors configured to detect not only the thickness of a recording medium but also surface properties representing smoothness and roughness, electric resistance, and the like of the recording medium.

As explained above, the media sensor 220 measures characteristic values of the recording media stored in the feeding cassette 210 before the recording media are sent to the conveying path. Measurement values of the characteristic values are stored in the memory unit 22.

In Act 22 of FIG. 7, the printer CPU 331 controls, on the basis of the measured characteristics of the recording media, the units of the image forming apparatus 1 to be adapted to the characteristics of the recording media. For example, the printer CPU 331 corrects a transfer bias output of the secondary transfer unit 260 on the basis of a surface electric resistance of the recording media and a type of the recording media. The fixing control unit 334 corrects the fixing temperature in the fixing unit 270 on the basis of the thickness of the recording media and the type of the recording media.

In FIG. 6, if the transmitted information is not the designation of a feeding cassette (No in Act 02), the CPU 21, in Act 03, edits print data. In Act 04, the CPU 21 determines, on the basis of the selection information of a feeding cassette transmitted in advance, the feeding cassettes 201, 202, 203, and 204 used for printing.

In Act 10, the CPU 21 starts a printing operation. In Act 11, the CPU 21 corrects the measurement values of the characteristics of the recording media according to a progress state of the printing. For example, the CPU 21 refers to a correction coefficient in a print table created and stored in the memory unit 22 in advance and, when the printing is stared and a predetermined number of sheets are printed, controls the units of the image forming apparatus 1 using values obtained by correcting the measurement values. Specifically, the CPU 21 corrects, every time ten sheets are printed, measured surface electric resistance of the recording media according to a value of the temperature and humidity sensor 280 and causes the image forming apparatus 1 to execute the printing.

If the printing is not completed in Act 12 (No in Act 12), the CPU 21 returns to Act 11 and continues the print control. If the printing ends (Yes in Act 12), the CPU 21 ends the processing.

In this embodiment, a characteristic point is that, at a point when a paper feeding method is designated and a feeding cassette is designated on a dialog screen, the media sensor detects characteristics of recording media stored in the designated feeding cassette. In other words, the media sensor starts detection of characteristics of the recording media without waiting for pressing of the OK button, which is usually pressed after sheet selection, i.e., without waiting for a setting decision signal. A change in image condition setting is started on the basis of a result of the detection.

Therefore, at a point when the OK button is pressed on the dialog screen and setting is decided, a change in image forming conditions corresponding to the recording media is already started. Therefore, it is possible to reduce time required for image formation.

When the media sensor detects characteristics of the recording media before the OK button is pressed as in this embodiment, it is desirable that the recording media are not started to be conveyed. Since, in some case, a feeding cassette is changed before the OK button is pressed, it is desirable that earlier feeding of the recording media is performed as fewer times as possible.

If the automatic paper selection is designated on the operation screen 34, characteristics of the recording media in the feeding cassette cannot be detected in advance. In that case, the CPU 21 selects, on the basis of information concerning a size of recording media on which images are formed included in received information, a feeding cassette to be used, causes the media sensor to detect characteristic values of recording media in the selected feeding cassette, satisfies at least one image forming condition on the basis of the detected characteristic values of the recording media, and starts the image forming operation on the basis of image data included in the received information.

A form of using the image forming apparatus 1 using the control panel 14 is explained below.

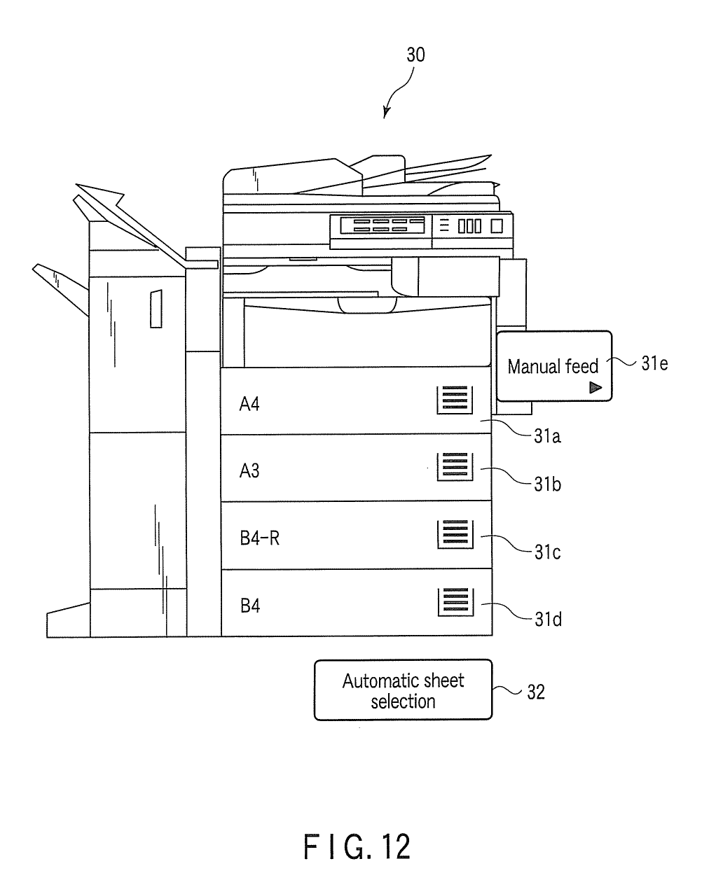

FIG. 12 is an exemplary diagram of an operation screen for selecting a feeding cassette displayed on the control panel according to an embodiment.

A figure of the image forming apparatus 1 is displayed on the operation screen 30. Icons 31a to 31e of feeding cassettes and an automatic sheet selection button 32 are displayed in the figure. Sizes of recording media are displayed on the icons 31a to 31e of the feeding cassettes. The user can designate, by selecting the icons 31a to 31e, a feeding cassette to be used. When the user operates the automatic sheet selection button 32, the image forming apparatus 1 automatically selects a feeding cassette.

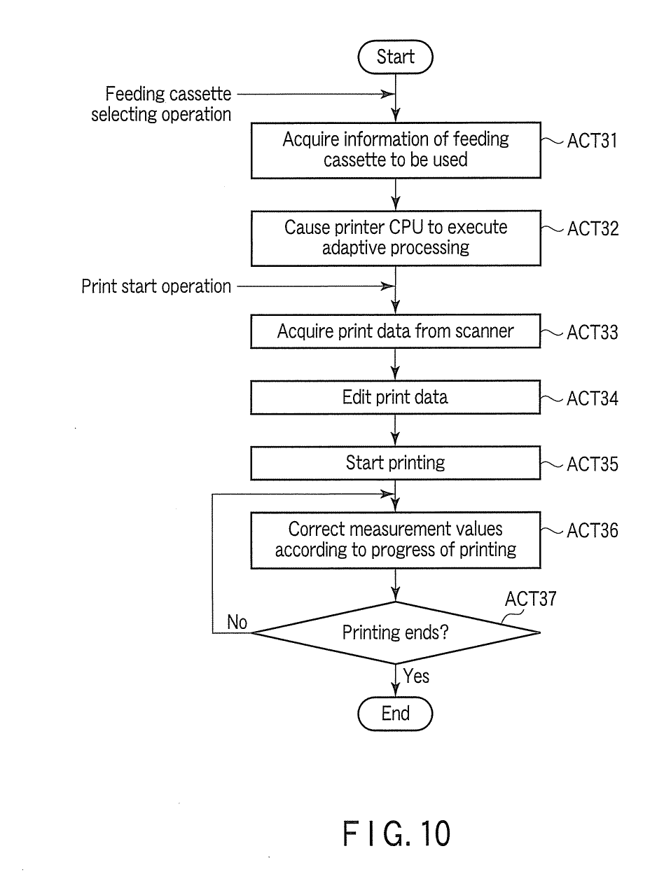

FIG. 10 is an exemplary flowchart for explaining a print processing procedure performed when a feeding cassette is designated on the control panel of the image forming apparatus according to an embodiment.

When the user selects a feeding cassette from the control panel 14, the CPU 21, in Act 31, acquires information concerning the feeding cassette to be used in printing. In Act 32, the CPU 21 causes the printer CPU 331 to execute adaptive processing. Since the content of the adaptive processing is the same as that in the procedure shown in FIG. 7, explanation of details of the adaptive processing is omitted.

When the user sets an original document on the ADF 112, designates the number of copies to be printed and the like simultaneously with the designation of a feeding cassette, and presses the OK button, the CPU 21, in Act 33, receives print data from the scanner CPU 311. In Act 34, the CPU 21 edits, in parallel to the adaptive processing, the print data in a form that can be processed by the printer CPU 331. In Act 35, the CPU 21 starts a printing operation. In Act 36, the CPU 21 corrects measurement values of characteristics of recording media according to a progress state of the printing.

If the printing is not completed in Act 37 (No in Act 37), the CPU 21 returns to Act 36 and continues the print control. If the printing ends (Yes in Act 37), the CPU 21 ends the processing.

Print data is not limited to the print data received from the scanner CPU 311 and may be stored in the memory unit 22.

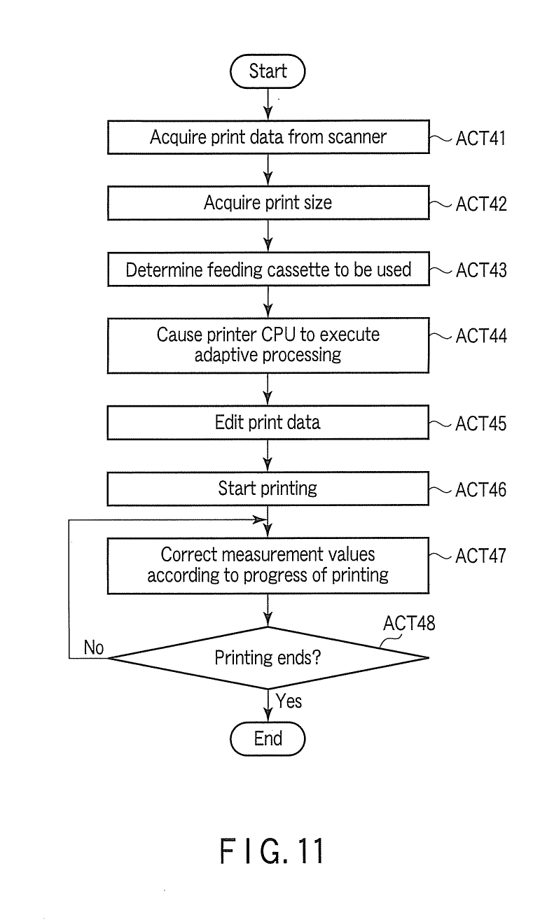

FIG. 11 is an exemplary flowchart for explaining a print processing procedure performed when an automatic sheet selection button is operated on the control panel of the image forming apparatus according to an embodiment.

When the user sets an original document on the ADF 112, designates the number of copies to be printed and the like simultaneously with the operation of the automatic sheet selection button 32, and presses the OK button, the CPU 21, in Act 41, receives print data from the scanner CPU 311. In Act 42, the CPU 21 acquires a size of a recording medium to be printed. In Act 43, the CPU 21 determines the feeding cassette 201, 202, 203, or 204 to be used for printing. In Act 44, the CPU 21 causes the printer CPU 331 to execute an adaptive processing. Since the content of the adaptive processing is the same as that in the procedure shown in FIG. 7, explanation of details of the adaptive processing is omitted.

In Act 45, the CPU 21 edits, in parallel to the adaptive processing, the print data in a form that can be processed by the printer CPU 331. In Act 46, the CPU 21 starts a printing operation. In Act 47, the CPU 21 corrects measurement values of characteristics of recording media according to a progress state of the printing. If the printing is not completed in Act 48 (No in Act 48), the CPU 21 returns to Act 47 and continues the print control. If the printing ends (Yes in Act 48), the CPU 21 ends the processing.

Print data is not limited to the print data received from the scanner CPU 311 and may be stored in the memory unit 22.

The functions explained in the embodiment may be configured by using hardware. The functions may be realized by causing a computer to read a computer program describing the functions using software. The functions may be configured by selecting the software or the hardware as appropriate.

It is also possible to realize the functions by causing the computer to read the computer program stored in a not-shown recording medium. The recording medium in this embodiment may be of any form as long as the recording medium can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a setting unit configured to set setting information for forming images on recording media;
one or more feeding units configured to store the recording media;
a media sensor configured to detect a characteristic value of the recording media stored in the feeding units;
an image forming unit configured to form images on the recording media on the basis of a detection result of the media sensor; and
a control unit configured to cause, at a time when a feeding unit that feeds the recording media is selected on the basis of the setting from the setting unit, the media sensor to detect a characteristic value of the recording media in the selected feeding unit and cause the image forming unit to satisfy at least one image forming condition on the basis of the detected characteristic value of the recording media.

2. The apparatus according to claim 1, wherein the control unit causes, after acquiring, from the setting unit, selection information of the feeding unit that feeds the recording media, the image forming unit to start an image forming operation on the basis of acquired image data when a start instruction for image formation is acquired from the setting unit.

3. The apparatus according to claim 2, wherein the media sensor is provided in a pickup member for extracting the recording media from the feeding unit one by one.

4. The apparatus according to claim 3, wherein the media sensor detects at least a value equivalent to electric resistance or a value equivalent to surface roughness or thickness of the recording media.

5. The apparatus according to claim 4, wherein the control unit causes, every time a predetermined number of sheets are printed, the image forming unit to update the image forming condition on the basis of a new characteristic value obtained by correcting the detected characteristic value of the recording media.

6. The apparatus according to claim 5, wherein
the setting unit displays icons corresponding to the one or more feeding units, and
sizes of the recording media are displayed on the icons.

7. The apparatus according to claim 6, further comprising a scanner configured to read an original document and converts the read information into image data, wherein
the image forming unit forms images on the recording media on the basis of the image data converted by the scanner.

8. The apparatus according to claim 6, further comprising a memory configured to store the image data, wherein
the image forming unit forms images on the recording media on the basis of the image data stored in the memory.

9. An image forming apparatus comprising:
a setting unit configured to set setting information for forming images on recording media;
one or more feeding units configured to store the recording media;
a media sensor configured to detect a characteristic value of the recording media stored in the feeding units that store the recording media on which images are formed;
an image forming unit configured to form images on the recording media on the basis of the detected characteristic value of the recording media; and
a control unit configured to select a feeding unit to be used on the basis of the content set by the setting unit when the setting unit designates a start of operation and a size of the recording media on which images are formed, cause the media sensor to detect a characteristic value of the recording media in the selected feeding unit, cause the image forming unit to satisfy at least one image forming condition on the basis of the detected characteristic value of the recording media, and cause the image forming unit to start an image forming operation when the setting unit designates the start of the operation.

10. The apparatus according to claim 9, wherein the media sensor is provided in a pickup member for extracting the recording media from the feeding unit one by one.

11. The apparatus according to claim 10, wherein the media sensor detects at least a value equivalent to electric resistance or a value equivalent to surface roughness or thickness of the recording media.

12. The apparatus according to claim 11, wherein the control unit causes, every time a predetermined number of sheets are printed, the image forming unit to update the image forming condition on the basis of a new characteristic value obtained by correcting the detected characteristic value of the recording media.

13. The apparatus according to claim 12, wherein
the setting unit displays icons corresponding to the one or more feeding units, and
sizes of the recording media are displayed on the icons.

14. The apparatus according to claim 13, further comprising a scanner configured to read an original document and converts the read information into image data, wherein
the image forming unit forms images on the recording media on the basis of the image data converted by the scanner.

15. The apparatus according to claim 13, further comprising a memory configured to store the image data, wherein
the image forming unit forms images on the recording media on the basis of the image data stored in the memory.

16. An image forming apparatus comprising:
one or more feeding units configured to store recording media;
a media sensor configured to detect a characteristic value of the recording media stored in the feeding units that stores the recording media on which images are formed;
an image forming unit configured to form images on the recording media on the basis of the detected characteristic value of the recording media; and
a control unit configured to cause, when information designating a feeding unit used for image formation is received from an external device, the media sensor to detect a characteristic value of the recording media in the designated feeding unit and cause the image forming unit to satisfy at least one image forming condition on the basis of the detected characteristic value of the recording media.

17. The apparatus according to claim 16, wherein the control unit causes, after receiving the information designating the feeding unit, when image data for image formation is received from the external device, the image forming unit to start an image forming operation on the basis of the image data.

18. The apparatus according to claim 17, wherein the media sensor is provided in a pickup member for extracting the recording media from the feeding unit one by one.

19. The apparatus according to claim 18, wherein the media sensor detects at least a value equivalent to electric resistance or a value equivalent to surface roughness or thickness of the recording media.

20. The apparatus according to claim 19, wherein the control unit causes, every time a predetermined number of sheets are printed, the image forming unit to update the image forming condition on the basis of a new characteristic value obtained by correcting the detected characteristic value of the recording media.
